(19) United States
(12) Patent Application Publication
(10) Pub. No.: US 2006/0106125 A1
(43) Pub. Date: May 18, 2006

(54) Use of highly branched polyols for the preparation of polyurethane foams, two-component foam systems containing these polyols, and their use

(75) Inventor: Michael Leitner, Landsberg (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 11/283,388

(22) Filed: Nov. 17, 2005

(30) Foreign Application Priority Data
Nov. 18, 2004 (DE) 10 2004 055 672.5

(51) Int. Cl. C08G 18/00

(52) U.S. Cl. 521/172

(57) ABSTRACT

Described are the use of highly branched and/or dendritic polyols with a number average molecular weight (Mn) of 500 to 100,000 g/mole and preferably of 1,000 to 10,000 g/mole and an average hydroxy functionality per molecule of 10 to 1000 and preferably of 25 to 100, as polyol for the preparation of polyurethane foams with a higher ratio of compressive strength to density, a two-component foam system for the preparation of polyurethane foams with a higher ratio of compressive strength to density, with a polyisocyanates component (A) and a component (B) (polyol component) containing compounds having reactive hydrogen atoms, which are present in separate containers and, for use, can be caused to react by being mixed, which is characterized in that the polyol component (B) contains 1 to 50% by weight and preferably 2 to 30% by weight, based on the weight of the compounds of the polyol component (B) having reactive hydrogen atoms, at least one highly branched and/or dendritic polyol (B1) with a number average molecular weight (Mn) of 500 to 100,000 g/mole and preferably of 1000 to 10,000 g/mole and an average hydroxy functionality per molecule of 10 to 1000 and preferably of 25 to 100, as well as the use of this two-component foam system as installation foam, especially for the installation of door and window frames or of staircases and/or as fire protection foam for sealing openings and/or wall bushings and/or ceilings of buildings.

### FIELD OF THE INVENTION

The object of the present invention is the use of highly branched and/or dendritic polyols for the preparation of polyurethane foams, especially semi-hard or hard polyurethane foams, with a higher ratio of compression strength to density, two-component foam systems for the preparation of polyurethane foams of this type, which contain those highly branched and/or dendritic polyols in the polyol component, as well as the use of such two-component foam systems as installation foam, especially for the installation of door and window frames, as staircase foam and/or as fire protection foam for sealing openings and/or wall bushings in walls and/or ceilings of buildings.

### BACKGROUND INFORMATION AND PRIOR ART

Hard polyurethane foams are used in various ways, for example, as installation forms for the installation of door and window frames and staircases or also as five protection foam. For these applications, the mechanical load carrying capacity of the polyurethane foams plays a major role, since the foam can no longer fulfill its original function to a sufficient extent after it has been excessively stressed mechanically. The compressive strength, which can be measured in standardized compression experiments, especially according to the DIN Standard 53 421, is the recognized criterion for the mechanical load-carrying capacity of such a foam.

Basically, the compressive strength of a foam is proportional to its density. This means that the compressive strength of a chemically equivalent foam system increases with the density of the foams. For example, conventional, commercial polyurethane foams with a density of 0.03 g/cc have a compressive strength of 0.11 MPa, those with a density of 0.05 g/cc have a compressive strength of 0.20 MPa and those with a density of 0.09 g/cc have a compressive strength of 0.60 MPa.

In general, the compressive strength of hard polyurethane foam systems is increased by introducing either suitable, inorganic fillers, such as glass fiber, or organic plasticizers, such as phthalate compounds, into the starting mixture for the preparation of the polyurethane foam. This is, however, disadvantageous since the addition of fillers leads to an increase in foam density and to a decrease in compressive strength of the foam system over time, since the fillers and also the organic plasticizers can migrate into and out of the foam matrix, because they are not incorporated covalently into the polyurethane network of the foam matrix.

On the other hand, the manufacturer and the user of polyurethane foams, especially of foams used as installation foams, is interested in keeping the foam density as low as possible, since by these means the amount of starting materials, required for filling a particular volume with foam, can be decreased, so that the material costs and, with that, the costs of producing and using this foam can be minimized.

### OBJECT OF THE INVENTION

It is therefore an object of the present invention to increase the compressive strength of hard polyurethane foam systems without increasing their density or to decrease the density of a foam system without loss in compressive strength, that is, it to provide polyurethane foams with a higher ratio of compressive strength to density.

### SUMMARY OF THE INVENTION

Surprisingly, it has turned out that this objective can be accomplished owing to the fact that certain highly branched and/or dendritic polyols are used as polyol or in the polyol component for the preparation of hard polyurethane foams.

The object of the present invention therefore is the use of highly branched and/or dendritic polyols with a number average molecular weight (Mn) of 500 to 100,000 g/mole and preferably of 1000 to 10,000 g/mole and an average hydroxy functionality per mole of 10 to 1000 and preferably of 25 to 100, as polyol for the preparation of polyurethane foams with a higher ratio of compressive strength to density.

Preferably, the highly branched and/or dendritic polyol, used pursuant to the invention, has an average degree of branching of more than zero and less than or equal to 1.0 and preferably of 0.2 to 0.66 and, particularly, of 0.53 to 0.59. According to definition, strictly linear polyols have a degree of branching of zero and ideally dendritic polyols have a degree of branching of 1.0.

With regard to the definition of highly branched and/or dendritic polyols, their synthesis and the definition of their molecular weight and their degree of branching, as well as the determination of the latter, reference is made to the publication by Alexander Sunder et al. concerning these highly branched and dendritic polyols in Macromolecules, 1999, 32, 4240-4246. Such highly branched and/or dendritic polyols are synthesized by polymerization of monomers of the ABₘ type, for example, by polymerization of glycidol, a cyclic monomers of the AB₂ type, which, when polymerized, yields a polyether polyol. During the polymerization of glycidol, linear 1,3 units, linear 1,4 units, dendritic units and terminal units are formed. The linear homopolymers with the 1, 3 or 1,4 linkages, respectively, have an average degree of branching of 0, whereas ideal, dendritic, homopolymers have an average degree of branching of 1.0. In this connection, the average degree of branching DB is defined by the following equation, which is disclosed in the reference cited:
DB=2D/(2D+L₁₃+L₁₄)
In the above equation, D represents the dendritic units, L₁₃ the linear 1,3 units and L₁₄ the linear 1,4 units. As in the reference cited, the average degree of branching can be determined by ¹³C-NMR spectroscopy.

The number average molecular weight (Mn) of the highly branched and/or dendritic polyols, used pursuant to the invention, as well as the average degree of branching, may be determined with the help of ¹H and ¹³C-NMR spectroscopy or calculated from the integrals of the individual structure units, contained in the polymers and ascertained with these spectra.

On the basis of these structural units, which can be ascertained experimentally, the following expression is obtained for the average degree of polymerization D\overline{P}ₙ for the highly branched polyols that are used pursuant to the invention:
D\overline{P}ₙ=ƒ_{c}(T+L₁₃+L₁₄+D)/(T−D)
in which ƒ_{c} represents the functionality of the core molecules.

The average degree of polymerization represents the sum of the integrals of the individual structure units, contained in the polymer, in the spectra mentioned.

The hydroxyl functionality of the polyols, used pursuant to the invention, corresponds to the number of terminal structure units T per molecule, that is, in the case of polyols, to the number of terminal hydroxyl groups per molecule, and amounts to 100 to 1000 and preferably 25 to 100, especially 20 to 40 and particularly 25 to 30.

Surprisingly, it has turned out that the highly branched and/or dendritic polyols with their high hydroxy functionality, used pursuant to the invention, lead to extremely high cross-linking densities which, depending on their concentration in the polyol mixture as a whole, lead to hard polyurethane foams with a significantly higher compressive strength at the same density. This result must be regarded as surprising since someone, of ordinary skill in the art, would have expected the brittleness of the polyurethane foam to increase when cross-linking molecules, which have clearly more than 5 cross-linking sites per molecule, are used to an increasing extent. As the brittleness of a foam increases, a decrease in compressive strength would therefore have been expected. Surprisingly, however, it has turned out that, by using these highly branched and/or dendritic polyols in an amount ranging from 1 to 50% by weight and preferably from 2 to 30% by weight, based on the weight of the compounds of the polyol component of a polyurethane foam system having reactive hydrogen atoms, it becomes possible, pursuant to the invention, to obtain hard polyurethane foams having the same density but a clearly higher compression strength.

By appropriately varying the concentration of the highly branched and/or dendritic polyol in the polyol component of the polyurethane foam system, the compression strength of already proven polyurethane foam systems can be improved in a simple manner. Since, pursuant to the invention, insoluble, inorganic fillers do not have to be introduced into the polyurethane foams, in order to increase their compression strength, the disadvantages, such as the migration of the fillers in the polyurethane foam, the high viscosity of the mixture to be applied and the costs of these fillers and plasticizers, are also eliminated. However, within the scope of the invention, it is, of course, possible to continue to use the usually employed inorganic and/or organic fillers in order to vary the density or other properties of the polyurethane foam selectively in this manner.

Pursuant to a preferred embodiment of the invention, the highly branched and/or dendritic polyol has a hydroxyl number of 50 to 5000 and preferably of 200 to 1000.

The hydroxyl number can be determined with the help of an end group titration of the polyols, used pursuant to the invention. For this, the terminal hydroxy groups are esterified quantitatively in the presence of a known excess of phthalic anhydride or a different cyclic anhydride. It has proven to be advantageous to use cyclic anhydrides for secondary alcohols, since the reactivity of these anhydrides is greater than that of acyclic anhydrides. The carboxylic acid, formed by the esterification, is titrated subsequently with aqueous KOH, from the consumption of which the hydroxyl number is then calculated. The hydroxyl number corresponds to the amount of KOH in mg required by 1 g of the polymer, in order to neutralize the phthalic acid formed. For this reaction, the esterification mixture consists of 450 mL of dry pyridine, 64.25 g of phthalic anhydride and 10 mL of N-methylimidazole. Pyridine (25 mL) and 50 mL of water are added to 25 mL of this mixture, which is then titrated with 1 N KOH after 15 minutes. The blank value (V_{blank}) is obtained in this way. A weighed amount of the polymer (mₛₐₘₚₗₑ) is then refluxed for 15 minutes with 25 mL of the esterification mixture. Subsequently, 25 mL of Pyridine and 50 mL of water are added in order to hydrolyze the excess anhydride. The solution is then titrated with 1 N KOH, Vₛₐₘₚₗₑ being obtained. For each polymer sample, the determination is carried out in duplicate. The hydroxyl number is then calculated with the help of the following equation:
OH number=56.1(V_{blank}−Vₛₐₘₚₗₑ)/mₛₐₘₚₗₑ

The highly branched and/or dendritic polyols in question, used pursuant to the invention, can be synthesized either by the procedure given in the Sunders et al. reference for the synthesis of the polyglycerols addressed there or by a similar method. Such highly branched and dendritic polyols are also available commercially, for example from Perstorp Polyols Inc., 600 Matzinger Road, Toledo, Ohio 43612, USA, for example, in the form of the Bottom H30 with a hydroxy functionality of 32 and a hydroxyl number of 500, or as Bottom H40 with a hydroxy functionality of 64 and a hydroxyl number of 485.

The highly branched and/or dendritic polyols, used pursuant to the invention, may also be polyether polyols, polyester polyols or mixtures thereof.

A further object of the invention is a two-component foam system for the preparation of polyurethane foams with a higher ratio of compression strength to density, with a polyisocyanate component (A) and a component (B) (polyol component), which contains compounds having reactive hydrogen atoms, the components being present in separate containers and, for use, caused to react by mixing, characterized in that the polyol component (B) contains 1 to 50% by weight and preferably 2 to 30% by weight, based on the weight of the reactive compounds of the polyol component (B) having reactive hydrogen atoms, at least one highly branched and/or dendritic polyol (B1) with a number average molecular weight (Mn) of 500 to 100,000 g/mole and preferably of 1000 to 10,000 g/mole and an average hydroxy functionality per molecule of 10 to 1000 and preferably of 25 to 100.

Preferably, in the polyol component (B), this two-component foam system contains a highly branched and/or dendritic polyol with an average degree of branching, which is greater than zero and smaller or equal to 1.0 and preferably ranges from 0.2 to 0.66 and especially from 0.53 to 0.59, as defined above. Preferably, the highly branched and/or dendritic polyol has a hydroxyl number of 50 to 5000 and preferably of 200 to 1000.

The polyisocyanate component (A) of this inventive two-component foam system comprises at least one polyisocyanate with an NCO content of 5 to 55% and preferably of 20 to 50% and, on the average, 2 to 5 and preferably 2 to 4 NCO groups per molecule.

In accordance with a preferred embodiment, the polyisocyanate component (A) comprises a polyisocyanate based on methylenediphenyl diisocyanate and/or polymeric homologs thereof, those polyisocyanates with an NCO content of 31% and, on the average, 2.7 NCO groups per molecule being particularly preferred.

Aside from the highly branched and/or dendritic polyol (B 1), the polyol component (B) of the inventive two-component foam system may comprise at least one polyol (B2) with a hydroxyl number of 30 to 1000 and preferably of 500 to 1000 and an average hydroxy functionality the molecule of 2 to 7 and preferably of 2 to 5 which is commonly used for the preparation of polyurethane foams. Someone, of ordinary skill in the art, is familiar with such polyols (B2) for the preparation of hard polyurethane foams.

Preferably, as polyol (B2), the two-component foam system contains at least one polyether polyol and/or one polyester polyol with a hydroxyl number of 300 to 1000 and preferably of 500 to 1000 and an average hydroxy functionality of 2 to 7 and preferably of 2 to 4 and/or at least one aminopolyether polyol and/or one polyol based on phosphate esters with a hydroxyl number of 30 to 1000 and preferably of 100 to 300 and an average hydroxy functionality per molecule of 2 to 7 and preferably of 3 to 5.

Preferably, the characteristic number of the polyurethane reaction ranges from 95 to 165 and preferably from 102 to 120. The characteristic number of the polyurethane reaction is understood to be the percentage ratio of the isocyanate groups used (amount of effectively used isocyanate groups (Π_{NCO}) to the active hydrogen atoms used (amount of effectively used active hydroxy function: Π_{active H}), which are supplied, for example, by the hydroxy groups of polyols, by amino groups of amines or by COOH groups of carboxylic acids. A stoichiometric amount of isocyanate corresponds to the characteristic number of 100 and a 10% excess of isocyanate groups corresponds to the characteristic number of 110. The formula, required for the calculation of the characteristic number of the polyurethane reaction, reads as follows:
Characteristic number=Π_{NCO}/Π_{H}×100

In accordance with a further preferred embodiment of the invention, the polyol component (B) contains water in an amount that results in a polyurethane foam with a foam density of 0.02 to 0.5 g/cc and preferably of 0.05 to 0.3 g/cc, one or more catalyst for the polyurethane formation reaction and optionally a foam cell stabilizer.

As catalyst for the polyurethane formation reaction, the polyol component (B) contains one or more tertiary amines, preferably dimorpholine diethyl ether and, as foam cell stabilizer, the polyol component (B) may contain a polysiloxane.

In accordance with a further embodiment of the invention, the polyisocyanate component (A) and/or the polyol component (B) may contain conventional fillers, auxiliary material and/or additives in the usual amounts.

These components may contain 0 up to 40% by weight and preferably 1 to 20% by weight of a filler, selected from sand, chalk, perlite, glass fibers, carbon black or mixtures thereof, 0 to 2% by weight and preferably 0.1 to 1% by weight of one or more dyes and/or 0 to 40% by weight and preferably 1 to 20% by weight of flame-retarding additive, in each case based on the weight of the two-component foam system.

In accordance with a preferred embodiment of the invention, the containers, which contained the polyisocyanate component (A) and the polyol component (B) are connected ever supply piping with a delivery device with a mixing head, in which the polyisocyanate component is mixed with the polyol component. Preferably, the delivery device has a mixing head in the form of a nozzle, which is provided with a static mixer. Furthermore, the containers are provided with extrusion devices, over which the polyisocyanate component (A) and the polyol component (B) can be brought into the mixing head of the delivery device. As extrusion devices, preferably mechanical pressing devices may be used and/or blowing gases, which are contained in the polyisocyanates component (A) and in the polyol component (B) and/or in the pressure chamber of a two-chamber cartridge for these components.

A further object of the invention is the use of the above-defined two-component foam system as an installation foam at building sites, especially for the installation of door and window frames and of staircases and/or as fire-protection for sealing openings and/or bushings in walls and/or ceilings of buildings. Preferably, for this use, the polyisocyanate component (A) and the polyol component (B) of the two-component foam system are mixed with the help of the delivery device with mixing head and introduced into the installation joints, the opening and/or the wall bushing and foamed there and cured.

The following examples and the comparison example explain the invention further.

### EXAMPLE 1

Preparation of a hard polyurethane foam using 12% highly branched polyglycerols (on the basis of the total polyol component). The polyglycol was synthesized by the method described by A. Sunder et al. (reference has been cited).

Using the components, given below, for the polyol component and the polyisocyanates component, a polyurethane hard foam was prepared by mixing the two components and foaming the material.

| | | OH- | OH- | |
|---|---|---|---|---|
| | Components | Number | Functionality | Mass/g |
| Polyol | Polyether polyol | 480 | 4 | 20 |
| Component | based on | | | |
| | ethylenediamine and | | | |
| | propylene oxide | | | |
| | 1,4-butylene glycol | 1240 | 2 | 10 |
| | Polyether polyol | 860 | 3 | 5 |
| | based on | | | |
| | trimethylolpropane | | | |
| | (TMP) | | | |
| | Polyglycerol | 760 | 27 | 5 |
| | Water | 6250 | 2 | 0.25 |
| | Polysiloxane (cell | | | 3 |
| | stabilizer) | | | |
| | Dimorpholine diethyl | | | 1.2 |
| | ether (catalyst) | | | |

| | | | NCO- | |
|---|---|---|---|---|
| | | NCO | Function- | |
| | | Content/% | ality | Mass/g |
| Polyisocynate | Based on methylene | 31 | 2.7 | 86 |
| Component | diphenyl diisocyanate | | | |
| | (MDI) and polymeric | | | |
| | homologs of MDI | | | |

The compression strength, determined here and in the following examples according to the DIN Standard 53 421 perpendicularly to the foaming direction for this inventive polyurethane is 1.9 MPa at a density of 0.12 g/cc.

### EXAMPLE 2

Preparation of a hard polyurethane foam using 7% of the highly branched polyglycerol used in Example 1 (based on the total polyol component).

| | | OH- | OH- | |
|---|---|---|---|---|
| | Components | Number | Functionality | Mass/g |
| Polyol | Polyether polyol | 480 | 4 | 20 |
| Component | based on | | | |
| | ethylenediamine and | | | |
| | propylene oxide | | | |
| | 1,4-butylene glycol | 1240 | 2 | 10 |
| | Polyether polyol | 860 | 3 | 7 |
| | based on | | | |
| | trimethylolpropane | | | |
| | (TMP) | | | |
| | Polyglycerol | 760 | 27 | 3 |
| | Water | 6250 | 2 | 0.25 |
| | Polysiloxane (cell | | | 3 |
| | stabilizer) | | | |
| | Dimorpholine diethyl | | | 1.2 |
| | ether (catalyst) | | | |

| | | | NCO- | |
|---|---|---|---|---|
| | | NCO | Function- | |
| | | Content/% | ality | Mass/g |
| Polyisocynate | Based on methylene | 31 | 2.7 | 86 |
| Component | diphenyl diisocyanate | | | |
| | (MDI) and polymeric | | | |
| | homologs of MDI | | | |

The compression strength of this inventive polyurethane hard foam, perpendicular to the foaming direction, is 1.7 MPa at a density of 0.12 g/cc.

### COMPARISON EXAMPLE

The preparation of a hard polyurethane foam without the use of the highly branched and/or dendritic polyol.

| | | OH- | OH- | |
|---|---|---|---|---|
| | Components | Number | Functionality | Mass/g |
| Polyol | Polyether polyol | 480 | 4 | 20 |
| Component | based on | | | |
| | ethylenediamine and | | | |
| | propylene oxide | | | |
| | 1,4-butylene glycol | 1240 | 2 | 10 |
| | Polyether polyol | 860 | 3 | 10 |
| | based on | | | |
| | trimethylolpropane | | | |
| | (TMP) | | | |
| | Water | 6250 | 2 | 0.25 |
| | Polysiloxane (cell | | | 3 |
| | stabilizer) | | | |
| | Dimorpholine diethyl | | | 1.2 |
| | ether (catalyst) | | | |

| | | | NCO- | |
|---|---|---|---|---|
| | | NCO | Function- | |
| | | Content/% | ality | Mass/g |
| Polyisocynate | Based on methylene | 31 | 2.7 | 86 |
| Component | diphenyl diisocyanate | | | |
| | (MDI) and polymeric | | | |
| | homologs of MDI | | | |

The compression strength of this comparison polyurethane foam perpendicular to the foaming direction is only 1.1 MPa at a density of 0.12 g/cc.

It is therefore evident that, pursuant to the invention, a significant increase in compression strength at the same density, that is, a higher ratio of compression strength to density can be achieved by using highly branched and/or dendritic polyols.

What is claimed is:

1. In a method for the preparation of polyol containing polyurethane foams with a higher ratio of compression strength to density, the improvement which comprises that as polyols are used highly branched and/or dendritic polyols with a number average molecular weight (Mn) of 500 to 100,000 g/mole and preferably of 1000 to 10,000 g/mole and an average hydroxy functionality per mole of 10 to 1000 and preferably of 25 to 100.

2. The method of claim 1, characterized in that the highly branched and/or dendritic polyol has an average degree of branching larger than zero and smaller or equal to 1.0 and preferably ranging from 0.2 to 0.66.

3. The method of claim 1, characterized in that the highly branched and/or dendritic polyol has a hydroxyl number of 50 to 5000 and preferably of 200 to 1000.

4. The method of claim 1, characterized in that the highly branched and/or dendritic polyol is a polyether polyol and/or a polyester polyol.

5. Two-component foam system for the preparation of polyurethane foams with a higher ratio of compression strength to density with a polyisocyanate component (A) and a component (B) (polyol component), containing compounds having reactive hydrogen atoms, which are present in separate containers and, for use, are caused to react by mixing, characterized in that the polyol component (B) contains 1 to 50% by weight and preferably 2 to 30% by weight, based on the weight of the compounds having reactive hydrogen atoms, at least one highly branched and/or dendritic polyol (B1) with a number average molecular weight (Mn) of 500 to 100,00 g/mole and preferably of 1000 to 10,000 g/mole and an average hydroxy functionality per molecule of 10 to 1000 and preferably of 25 to 100.

6. The two-component foam system of claim 5, characterized in that the highly branched and/or dendritic polyol has an average degree of branching of larger than zero and smaller than or equal to 1.0 and preferably of 0.2 to 0.66.

7. The two-component foam system of claim 5, characterized in that the highly branched and/or dendritic polyol has a hydroxyl number of 50 to 5000 and preferably of 200 to 1000.

8. The two-component foam system of claim 5, characterized in that the highly branched and/or dendritic polyol is a polyether polyol and/or a polyester polyol.

9. The two-component foam system of claim 5, characterized in that the polyisocyanates component (A) comprises at least one polyisocyanates with an NCO content of 5 to 55% and preferably of 20 to 50% and an average number of 2 to 5 and preferably of 2 to 4 NCO groups per molecule.

10. The two-component foam system of claim 9, characterized in that the polyisocyanate component (A) comprises a polyisocyanate based on methylene diphenyl diisocyanate and/or polymeric homologs thereof.

11. The two-component foam system of claim 10, characterized in that the polyisocyanate component (A) comprises a polyisocyanate based on methylene diphenyl diisocyanate and/or polymeric homologs thereof with an NCO content of 31% and, on the average, 2.7 NCO groups per molecule.

12. The two-component foam system of claim 5, characterized in that the polyol component (B), aside from the highly branched and/or dendritic polyol (B1), comprises at least one polyol (B2) with a hydroxyl number of 30 to 1000 and preferably of 500 to 1000 and with a hydroxy functionality per molecule of 2 to 7 and preferably of 2 to 5.

13. The two-component foam system of claim 12, characterized in that the polyol (B2) comprises at least one polyether polyol and/or polyester polyol with a hydroxyl number of 300 to 1000 and preferably of 500 to 1000 and an average hydroxy functionality of 2 to 7 and preferably of 2 to 4 and/or at least one aminopolyether polyol and/or a polyol based on phosphate esters with a hydroxyl number of 30 to 1000 and preferably of 100 to 300 and an average hydroxy functionality per molecule of 2 to 7 and preferably of 3 to 5.

14. The two component foam system of claim 5, characterized in that the characteristic number of the polyurethane reaction ranges from 95 to 165 and preferably from 102 to 120.

15. The two-component foam system of claim 5, characterized in that the polyol component (B) contains water in an amount, which yields a polyurethane foam with a foam density of 0.02 to 0.5 g/cc and preferably of 0.05 to 0.3 g/cc, one or more catalysts for the polyurethane formation reaction and optionally a foam cell stabilizer.

16. The two-component foam system of claim 15, characterized in that the polyol component (B) contains, as catalysts for the polyurethane formation reaction, one or more tertiary amines, preferably dimorpholine diethyl ether.

17. The two-component foam system of claim 9, characterized in that the polyol component (B) contains a polysiloxane as foam cell stabilizer.

18. The two-component foam system of claim 5, characterized in that the polyisocyanates component (A) and/or the polyol component (B) contain conventional fillers, auxiliary materials and/or additives in the usual amounts.

19. The two-component foam system of claim 18, characterized in that it contains 0 to 40% by weight and preferably 1 to 20% by weight of a filler, selected from sand, chalk, perlite, glass fibers, carbon black or mixtures thereof, 0 to 2% by weight and preferably 0.1 to 1% by weight of one or more dyes and/or 0 to 40% by weight and preferably 1 to 20 percent by weight of a flame-retardant additive, in each case based on the weight of the two-component foam system.

20. The two-component foam system of claim 5, characterized in that the containers, which contain the polyisocyanate component (A) and the polyalcohol component (B), are connected over the supplying piping with a delivery device with mixing head, in which the components are mixed.

21. The two-component foam system of claim 20, characterized in that the delivery device has a mixing head in the form of a nozzle, which is provided with a static mixer.

22. The two-component foam system of claim 20, characterized in that the containers are provided with extrusion devices, over which the polyisocyanates component (A) and the polyalcohol component (B) in the mixing head of the delivery device can be extruded.

23. The two-component foam system of claim 22, characterized in that, as extrusion devices, it comprises mechanical pressing devices and/or blowing gases, which are contained in the polyisocyanate component (A) and in the polyol component (B) and/or in the pressure chamber of a two-chamber cartridge for these components.

24. A method of using the two-component foaming system of claim 5 as installation foam, especially for the installation of door and window frames or of staircases and/or as fire-protection foam for sealing openings and/or wall bushings and/or ceilings of buildings.

25. The method of claim 24, characterized in that the polyisocyanate component (A) and the polyol component (B) of the two-component foam system are mixed with the help of the delivery device with mixing head and brought into the installation joints, the opening and/or the wall bushing, where they are foamed and permitted to cure.

26. The polyurethane foam product obtained by the method of claim 1.
